(19) United States
(12) Patent Application Publication
(10) Pub. No.: US 2023/0406130 A1
(43) Pub. Date: Dec. 21, 2023

(54) AUTOMATED CHARGING PROCESS FOR A MOTOR VEHICLE

(71) Applicant: Robert Bosch GmbH, Stuttgart (DE)

(72) Inventors: Benoit Budiscak, Hohenhaslach (DE); Rolf Nicodemus, Bietigheim-Bissingen (DE); Ronald Remy, Ludwigsburg (DE); Stefan Nordbruch, Leonberg (DE)

(21) Appl. No.: 18/313,245

(22) Filed: May 5, 2023

(30) Foreign Application Priority Data
May 23, 2022 (DE) 10 2022 205 101.7

(51) Int. Cl. B60L 53/36; B60L 53/66; B60L 58/12

(52) U.S. Cl. CPC B60L 53/36; B60L 2240/70; B60L 58/12; B60L 53/66

(57) ABSTRACT

An automated charging process for a battery of a motor vehicle. The method includes: transmitting a charging request for the battery from a first data transmission unit to a second data transmission unit which is part of a charging management system and is connected to a computing unit of the charging management system, the charging management system being assigned a parking lot for motor vehicles which includes a plurality of stop positions; determining a battery status of the battery; determining a charging strategy for the motor vehicle for charging the battery by the computing unit taking into account the battery status; and moving the motor vehicle to a suitable charging position of the parking lot and charging the battery of the motor vehicle according to the charging strategy in the suitable charging position by a charging station assigned to the suitable charging position.

### CROSS REFERENCE

The present application claims the benefit under 35 U.S.C. § 119 of German Patent Application No. DE 10 2022 205 101.7 filed on May 23, 2022, which is expressly incorporated herein by reference in its entirety.

### FIELD

The present invention relates to the field of charging stations for motor vehicles and relates to a method for carrying out an automated charging process for a battery of a motor vehicle and a charging management system for a parking lot for motor vehicles as well as a corresponding parking lot.

### BACKGROUND INFORMATION

The proportion of electric vehicles and hybrid vehicles is continuously increasing, but the infrastructure, in particular the number of charging stations, is often insufficient. A large number of motor vehicles have to share them.

Methods and systems to automate the parking of motor vehicles in parking lots, parking garages and the like, and in this context also to carry out charging processes for batteries of motor vehicles, are described in the related art. German Patent Application No. DE 10 2014 221 754 A1, for example, describes a method for carrying out an automated parking operation, in which a reservation request for a parking position is sent to a parking lot management server and the vehicle is autonomously navigated to the reserved parking position in the parking lot.

The reservation request can also include a parking position with a charging bay for electric vehicles. German Patent Application No. DE 10 2011 084 124 A1 similarly discusses a method for navigating a vehicle to a parking space and discloses the option of driving an electric vehicle to a suitable place in the parking lot for charging. Lastly, German Patent Application No. DE 10 2015 204 366 A1 describes a system for controlling the release of a parking space for a motor vehicle in combination with an electrical charging device in the region of the parking space for charging an electrical drive energy store.

### SUMMARY

According to the present invention, a method for carrying out an automated charging process for a battery, preferably a drive battery, of a motor vehicle, in particular an electric vehicle or a hybrid vehicle, is provided. Advantageous embodiments of the present invention are disclosed herein.

The method according to an example embodiment of the present invention comprises the following steps: Transmitting a charging request for the battery of the motor vehicle from a first data transmission unit to a second data transmission unit which is part of a charging management system and is connected to a computing unit of the charging management system, wherein the charging management system is assigned a parking lot for motor vehicles and the parking lot comprises a plurality of stop positions, determining a battery status of the battery, determining a charging strategy for the motor vehicle for charging the battery of the motor vehicle by the computing unit of the charging management system taking into account the battery status and lastly moving the motor vehicle to a suitable charging position of the parking lot (preferably in a fully automated manner) and charging the battery of the motor vehicle according to the charging strategy in the suitable charging position by a charging station assigned to the suitable charging position at a charging time and for a charging duration wherein at least the charging time and the charging duration arise from the charging strategy. The charging time and the charging duration do not have to be specified directly by the charging strategy (i.e. they do not have to be a direct part of it), but can also arise from the charging strategy in some other way. A charging duration can arise from a current state of charge (actual state of charge) of the battery and a required state of charge (target state of charge) and other properties of the battery and/or the charging station, for instance. A suitable charging position can arise from the charging strategy and/or be part of the charging strategy, but can also be set independently thereof, for example by a human user. It is also possible for a plurality of parking lots to be assigned to a single charging management system, which can be implemented as a computer system that can be accessed via the Internet, for example.

In a particularly advantageous embodiment of the present invention, a charging strategy is determined taking into account both the battery status and an expected remaining battery life of the battery after the battery has been charged. Such a consideration of an expected remaining battery life typically includes determining one or more remaining battery lives while taking into account the battery status. This can be accomplished in an iterative procedure, for instance, in that, after determining a preliminary charging strategy L₁ which is being considered, the expected remaining battery life after the charging process R₁ is determined, for example on the basis of the parameters of the charging strategy L₁ and the battery status. It can then be checked whether the remaining battery life R₁ meets specific criteria with such a charging strategy L₁; i.e. deviates only by a specific value from the current remaining battery life prior to the charging process, for example. If this is not the case, the preliminary charging strategy L₁ could be discarded and a new preliminary charging strategy L₂ with different parameters (for example a different charging duration and/or a different charging method) could be determined, until a charging strategy Lᵢ has been found with which the specific criterion for the expected remaining battery life Rᵢ is met. This charging strategy Lᵢ is then the charging strategy that is used to charge the motor vehicle.

In the context of this present invention, a battery status is understood to be the data relating to at least one parameter and/or a property of a battery needed by the charging management system to determine a charging strategy for the motor vehicle or to be taken into account for said determination. The determination of a charging strategy typically requires further information in addition to the battery status; for example information relating to the infrastructure of the parking lot (such as information relating to the stop positions and the charging positions and the properties of the charging stations) and/or relating to possible requests of a user of the motor vehicle, such as a desired departure time. A battery status can in particular include any parameters needed for determining an expected remaining battery life of the battery. A battery status can therefore include a nominal voltage, a battery capacity, an energy content of the battery, a power of the battery, a self-discharge, a charging rate, a temperature of the battery (battery temperature), a recommended charging method and/or an actual state of charge of the battery, for example. A state of charge (SOC, level) is a capacity of a battery in relation to its maximum capacity, typically indicated in percent, so the term actual state of charge refers to the current capacity and the term target state of charge refers to a desired capacity. A parameter and/or a property of a battery can be ascertained by means of one or more sensors, for example, and/or, in the case of a fixed property or a fixed parameter of the battery, retrieved from a database.

According to an example embodiment of the present invention, a battery status can be transmitted with a charging request, wherein a charging request is a data set that is suitable for informing a charging management system that a charging process of a battery of a motor vehicle is desired, i.e. includes a notification that charging is desired (the minimum data set for information about a desired charging process). In addition to the actual notification that charging is desired, a charging request can include other information needed by the charging management system to determine a charging strategy. Information relating to a battery status can be transmitted with the charging request, but any other information is possible too, in particular information relevant to the desired charging process (for example requests such as a planned departure time, a target state of charge of the battery, a tank fill level for a hybrid vehicle, a planned route, an average and/or planned energy consumption of the motor vehicle and/or data to be taken into account for the determination of a planned energy consumption, such as weather data, because the operation of the air conditioner or the like requires energy, or data about the volume of traffic on a planned route, because driving in slow-moving traffic with frequent acceleration and braking involves above average energy consumption). A charging request does not necessarily have to be one data set that is transmitted contiguously; it can also be divided into multiple data transmissions that are separated temporally and/or logically, provided that all of the data transmissions can be assigned to one another. It is therefore possible that a signal indicating that a charging of a battery is generally desired (notification that charging is desired) is sent to a charging management system or its data transmission unit first, and that further information is transmitted separately and with a time delay, possibly also only at the request of the charging management system. Such further information can be included in data relating to the current battery status, for example. A notification that charging is desired combined with additional information relevant to the charging strategy thus represents a single charging request within the meaning of the present invention.

It is therefore possible that the battery status or a component of the battery status is part of the charging request and/or the battery status is transmitted to the charging management system separately from the charging request and/or the battery status is transmitted to the charging management system by an external computing unit connected to the charging management system. The battery status or a component of the battery status can thus in particular be provided by a system other than the first data transmission unit. For instance, the battery status or the component of the battery status could be provided by the charging management system itself, which had previously received the separate transmission of the battery status, and/or by another external computing unit connected to the charging management system. It is thus possible that the battery status or components of the battery status (in particular non-constant parameters such as an actual state of charge and/or a battery temperature) be monitored continuously, in particular regularly, and transmitted to a computing unit connected to the motor vehicle by means of mobile communications (for example a cloud computing system connected via the Internet) and stored there in a database. The charging management system can in particular comprise or be connected to such a computing unit. When necessary, for example after receiving the charging request, the battery status or components of the battery status can then be retrieved from the database by the charging management for determining the charging strategy.

In particular for fixed (constant) properties and/or parameters of the battery, it is advantageous for the charging management system to use its own database or a database connected to the charging management system to ascertain said properties/parameters. In such a case, an identifier of the type of battery and/or the type of vehicle being used could be transmitted to the charging management system together with the battery status as part of the charging request, and the required fixed properties and/or parameters of the battery could be ascertained with the help of this Information. It would, for example, be possible for the battery capacity, the charging rate of the battery and/or recommended charging methods for the battery to be queried from such a database. If only fixed properties and/or parameters of the battery are to be retrieved from such a database, there is no need for ongoing monitoring and transmission of this component of the battery status to the database.

Alternatively or in addition to a database outside the motor vehicle, it is also possible that fixed properties and/or parameters of the battery be retrieved from a database located in a computing unit of the motor vehicle. In this case, the data could be retrieved by the charging management system and/or the first data transmission unit, for example, wherein, in the latter case, the first data transmission unit could transmit this data (for example as part of the charging request) to the charging management system.

In the context of the present invention, a parking lot refers to an environment and/or a building that is configured for parking motor vehicles, for example a parking garage, a parking space, a large parking garage, an underground parking garage or combinations of these possibilities. Parking garages and parking lots with an automated parking system (AVP, automated valet parking) are particularly advantageous for implementing the present invention. A stop position should be understood to mean a part of a parking lot that is suitable for allowing a motor vehicle to be left there, for example parked there, without being configured to carry out a charging process of a battery of a motor vehicle parked there. A parking lot typically comprises a plurality of stop positions. On the other hand, a charging position within the meaning of the present invention is a part of a parking lot in which a battery of a motor vehicle positioned there can be charged. For this purpose, a charging position is typically assigned a charging station, wherein a charging station is a device that is used to charge a battery; it can thus be a charging station for electric vehicles for example. Within the meaning of the present invention, a charging position is therefore not a stop position.

The electrical energy can be transmitted from the charging station to the motor vehicle via a cable connection, for example a plug connection, and/or inductively. In the context of this invention, such a cable connection can be established with human help, for example by a user of a motor vehicle to be charged and/or another person. The use of an automaton, for example a fully automated robot, which ensures that the cable connection is established, is alternatively possible too, however.

According to an example embodiment of the present invention, a data transmission unit of a charging station can be connected to a data transmission unit of the charging management system via a wired and/or wireless connection (radio link, for example via WLAN), for example to inform the computing unit of the charging management system about its own status and/or to transmit a charging strategy or parts of a charging strategy from the charging management system to the charging station. Such a charging station can also receive information from a data transmission unit of a motor vehicle, for example the charging strategy determined for the motor vehicle or parts of the specific charging strategy, such as the charging duration and/or the charging time. Providing a charging station with all of the information needed for the charging process, such as the charging duration and the charging time, either by the charging management system directly or by a motor vehicle to be charged, advantageously makes it possible to carry out fully automated charging of a motor vehicle.

In the context of the present invention, a charging strategy is a specification of how a battery of a motor vehicle is to be charged and can include any information needed and/or helpful for charging a battery. A charging strategy can, for instance, be in the form of a set of parameters for a charging station to be used for charging the battery of the motor vehicle. A charging strategy is determined automatically by a computing unit of the charging management system on the basis of a charging request and possibly taking into account other parameters (such as other charging requests from other motor vehicles). It is possible that such a charging strategy be checked again by a human user prior to use and then accordingly approved, modified or rejected.

For all data transmission units (computing units for transmitting data) used in the present invention, it is possible that they communicate with one another by means of wireless and/or wired data transmission. The data transmission unit of the charging management system can be a computer that can be accessed via a cellular network, for instance, (for example by means of “Cellular V2X”), for example an Internet server. The data transmission unit of the charging management system and the computing unit of the charging management system can communicate with one another as well by means of wired transmission, but also by means of wireless transmission. The transmission unit and the connected computing unit of the charging management system can also be implemented in a single computer and the data transmission between the two units can be carried out in a program running on the computer or between multiple programs running on the computer.

Alternatively or additionally, a motor vehicle or a data transmission unit of the motor vehicle can also be connected to the data transmission unit of the charging management system of a parking lot by means of vehicle-to-infrastructure communication (V2I communication). A data transmission unit of the charging management system can thus also be located in the vicinity or near (preferably 500 m, particularly preferably 100 m, very particularly preferably 10 m away) the parking lot. In such a case, the data does not have to be transmitted via long-range cellular technologies, but can also be in the form of dedicated short-range communications (DSCR) on the basis of WLAN-based technologies such as pWLAN (IEEE 802.11p). It is possible, for instance, that the parking lot is an AVP-enabled parking garage and a charging request is transmitted using pWLAN or a similar standard. Communication between a data transmission unit of the motor vehicle and a data transmission unit of a charging station can likewise be carried out using such WLAN-based technologies.

According to the present invention, it has been recognized that the prior art does not disclose any methods or devices with which a charging process for a motor vehicle comprising a battery, in particular an electric vehicle and a hybrid vehicle, can be carried out efficiently in a parking lot comprising a plurality of stop positions for motor vehicles and one or more charging stations in the presence of a large number of charging requests for batteries of other motor vehicles. It has also been recognized that a solution to this problem lies in defining charging strategies for motor vehicles taking into account a battery status in order to enable the best possible planning of the charging processes, in particular when there are a large number of vehicles to be charged simultaneously or close in time to one another. Appropriately optimized charging strategies can prevent a motor vehicle standing at a charging position longer than necessary and blocking a charging station. A motor vehicle can be parked at a stop position of the parking lot as soon as the charging process is complete, for instance. If necessary, this can be accomplished in an automated matter.

The method according to the present invention may thus enable optimum use of an infrastructure of a parking lot for motor vehicles and the charging stations available there, in particular for electric vehicles and hybrid vehicles. Instead of increasing the number of charging stations as the number of vehicles increases, the present invention enables efficient charging of every motor vehicle, even with a small number of charging stations.

Additionally taking into account an expected remaining battery life after the battery has been charged when determining the charging strategy further makes it possible to achieve that the batteries are not unnecessarily damaged by the charging processes. Battery wear and the likelihood of premature battery aging are thus reduced compared to the prior art.

According to a variant of the method according to the present invention, the motor vehicle can comprise the first transmission unit, for example, and/or the first data transmission unit can be part of a mobile terminal device, such as a cell phone or a tablet computer, which is operated by a user of the motor vehicle, for instance. A corresponding app for creating and transmitting a charging request by the user could, for instance, be configured like a booking system into which a payment process can also be integrated. It is moreover also possible that the first data transmission unit is comprised in a navigation device of the motor vehicle. It is also possible that the first data transmission unit is part of a parking pay station, for example disposed in or on the parking lot or in the vicinity (preferably 500 m, particularly preferably 100 m, very particularly preferably 10 m away) of the parking lot.

In an advantageous embodiment of the present invention, it can be provided that determining the charging strategy is followed by transmitting the charging strategy for the motor vehicle to the first data transmission unit via the second data transmission unit of the charging management system. This ensures that the motor vehicle or its user (i.e. the driver in the case of partially automated motor vehicles) receives the information relating to the charging strategy via the same information channel as that via which the charging request was sent. The path to the suitable charging position, for instance, and/or the coordinates of the suitable charging position and/or an identifier of the suitable charging position and/or a possible route to the suitable charging position can be transmitted to the first data transmission unit as well as part of the transmission of the charging strategy in order to ensure that the motor vehicle or its user can drive to the charging position. Alternatively, it is also possible that only parts of the charging strategy are transmitted to the first data transmission unit and other information is transmitted from the charging management system to a data transmission unit of a charging station of the suitable charging position as long as the charging station and the charging management system are connected to one another wirelessly (for example via WLAN) and/or wired. For instance, it could be that only the path to the suitable charging position and/or its identifier and/or coordinates are transmitted to a data transmission unit of the motor vehicle or a mobile terminal device, and the remaining data of the charging strategy, including an identifier of the motor vehicle, are transmitted to the data transmission unit of the charging station of the suitable charging position. The charging station can thus be informed which motor vehicle is to be charged at what time and for how long. It is also possible that the charging strategy is not transmitted to the first data transmission unit, but is instead transmitted to a data transmission unit of a charging station of the suitable charging position. In the latter case, the user of the motor vehicle to be charged can be informed about the further procedure by a means other than the first data transmission unit, for example via a further data transmission unit of a device accessible to the user and/or by optical signals, for example a display mounted in the region of the suitable charging position. Such optical signals or other additional ways to inform the user can of course also be provided in the other cases mentioned above and are generally advantageous.

In particular when the first data transmission unit is a mobile terminal device, it makes sense to transmit at least parts of the charging strategy to this first data transmission unit: The user of a motor vehicle could then use a mobile terminal device, such as a smart phone, via which he also sent the charging request to the charging management system of a parking lot, for example a parking garage, to receive information about where to drive the car in a parking garage in order to reach the charging position assigned to the motor vehicle as quickly as possible. Coordinates, an identifier and/or a route to a position for temporarily parking the motor vehicle (i.e., a stop position), for instance, could alternatively be transmitted as well to enable temporary parking of the vehicle if no charging position can currently be made available.

If the user of the motor vehicle uses a mobile terminal device, it is generally particularly advantageous (regardless of whether the user makes the charging request via this terminal device, i.e., the mobile terminal device is the first data transmission unit) to provide information from the charging management system about important events, such as the completion of the charging process, to the user via the mobile terminal device. It is generally possible to keep the user of a motor vehicle informed about the current status of his or her motor vehicle as a charging process according to the method according to the present invention is being carried out and/or to enable the user to influence the procedure even after the charging request has been made, for example to request the motor vehicle sooner than originally planned and/or to terminate a charging process.

According to a variant of the method according to the present invention, the determination of the charging strategy can also include determining and/or taking into account a suitable charging position (if the parking lot comprises multiple charging positions) and/or the charging time and/or a charging duration and/or a target state of charge and/or a charging method (for example a fast charging method or a method that is especially battery-saving for the battery). In particular a charging position and/or a charging time and/or a charging duration and/or a target state of charge and/or a charging method can be part of the charging strategy. The determination of the charging strategy can also take into account specific requirements that can be part of a charging request. According to the present invention, in particular requirements such as a planned departure time and/or a target state of charge of the battery of the motor vehicle to be charged, which can in particular be wishes of a user, such as the user's desired departure time and/or a desired state of charge after charging, can thus be part of the charging request. Other information, such as a user's indication of his or her flexibility with respect to a request and/or a user's specified general prioritization, for example a time frame in which the user would like the charging process to be completed, can be part of a charging request as well. Such user requests therefore include a tolerance range. All requirements can be taken into account when determining the charging strategy.

According to an example embodiment of the present invention, it is particularly advantageous if the charging strategy is determined in such a way that the expected remaining battery life after the battery has been charged is maximized while satisfying one or more requirements for the charging strategy, such as a planned departure time and/or a target state of charge of the battery. In other words, the charging strategy is determined according to the present invention in this variant in such a way that the expected remaining battery life is at a maximum when all requirements for the charging strategy (such as user requests regarding a desired time frame for the completion of the charging process) are satisfied. The requirements therefore represent boundary conditions with respect to this optimization, wherein requirements provided with tolerance ranges (for example, flexible customer requests) are soft boundary conditions. As an alternative to maximizing the expected remaining battery life after the battery has been charged, the charging strategy can also be determined taking into account the expected remaining battery life such that the expected remaining battery life satisfies other criteria, for example that the expected remaining battery life after the charging process can only deviate from the remaining battery life prior to the charging process by a certain amount.

When determining the charging strategy taking into account an expected remaining battery life, it is also possible that, in order to protect the battery and maximize the expected remaining battery life, further measures, which are taken to improve the expected remaining battery life or to make the charging process less harmful to the battery, are part of the charging strategy in addition to optimized charging of the battery. In the case of a battery temperature that is unfavorable for a charging process, for example, this can in particular be a waiting period and/or an active heating or cooling process with a heating or cooling element to bring the battery to a more suitable temperature for the charging process.

If it is found before or during the determination of the charging strategy that it is not possible to fulfill all user requests, for example due to technical limitations, it is possible that the user is prompted, for example via a mobile terminal device of the user and/or the system via which the charging request was made, to decide between certain variants and/or redefine the user requests. A possible example here is that the user is given a choice between maximizing the remaining battery life and some other preference, such as a fully charged battery. If a user wants the battery of a motor vehicle to be fully charged and a departure time in two hours, for example, but a maximally battery-saving charging process also takes two hours but cannot start for another 30 minutes because the battery has to still be brought to an optimal temperature, the user could be prompted to choose between a battery-saving charging process and a fully charged battery.

According to an example embodiment of the present invention, it is also advantageous if the charging request comprises data regarding a planned route for the motor vehicle and these are taken into account when determining the charging strategy. This variant of the present invention can be implemented particularly advantageously if the navigation device provides the data for the route. According to the present invention, this can be taken into account, for example, in that, based on the planned route and an estimated energy consumption for the route (wherein additional data such as weather data or data about the volume of traffic on the planned route can be included in this estimate, which can also be part of the charging request and/or are ascertained separately by the charging management system), the battery of the motor vehicle can be charged just enough to reach the destination (if necessary with a safety buffer), or also that a desired state of charge will still be present when the destination is reached, i.e., the battery is still 30% charged, for example. Such a destination can, for instance, be another charging station at which the battery can be recharged. Such a charging station as a destination can also be suggested by the charging management system to a user of the motor vehicle (i.e. the driver of the motor vehicle, for example) and can also be imported directly into the navigation system of the motor vehicle. Such embodiments of the present invention ensure that the state of charge is sufficiently high to reach the desired destination.

In a particularly advantageous and important development of the present invention, the charging strategy is determined taking into account other charging strategies of other motor vehicles and/or other charging requests for batteries of other motor vehicles. Therefore, if other motor vehicles have also transmitted charging requests to the charging management system, these motor vehicles or the charging strategies determined for these motor vehicles can be taken into account when determining the charging strategy, for example with regard to determining the suitable charging position (if the parking lot has multiple charging positions) and/or the charging time and/or a charging duration and/or a target state of charge of the battery, such that the desired requirements (for example wishes of the user of the motor vehicle) are satisfied in the best possible way for all motor vehicles for which the charging of their battery based on the respective charging strategy could not be carried out yet or at least could not be carried out completely yet. The charging strategy for a motor vehicle can be determined taking into account a charging strategy of another motor vehicle and/or a charging request for a battery of another motor vehicle, for instance, after the other motor vehicle has already sent its own charging request to the computing unit of the parking lot and/or a charging strategy has been determined for that other motor vehicle.

If a charging management system has simultaneous charging requests from a plurality of motor vehicles, the charging strategies can also be determined taking into account the respective other charging requests (the best possible fulfillment of the boundary conditions and preferably also a maximation of the expected remaining battery life after the battery has been charged while at the same time avoiding conflicts of the charging strategies), and the charging strategies for the motor vehicles can preferably be determined simultaneously or close in time.

According to an example embodiment of the present invention, the task of optimally specifying the charging strategy for a plurality of existing charging requests for different vehicles and the resulting boundary conditions that should ideally be satisfied is a machine occupancy planning (scheduling) task. The charging time and the charging duration for each motor vehicle may have to be coordinated with boundary conditions such as the transmitted battery status, the properties of the charging station, a planned arrival time at the parking lot, a planned departure time from the parking lot, a planned route (and thus the required charging duration for said route), the energy consumption, and/or a customer-desired prioritization for the vehicle. A variety of optimization algorithms from the field of machine occupancy planning can be used for a corresponding specification pf the charging strategies. Since there is no perfect solution in certain cases, it can be useful to weight the boundary conditions differently. It can also be advantageous to specify at least a portion of the boundary conditions flexibly (provided with a tolerance range); for instance, with respect to the departure time, define a later, optional departure time that can be used under certain conditions. As an alternative to the use of more complex algorithms, it is of course also possible to define simpler procedures, such as a decision tree or a decision matrix, for specifying a charging strategy for a motor vehicle. It is also possible to use a human user to check, and optionally also modify or reject, the charging strategy determined for a motor vehicle by the computing unit of the charging management system.

A particularly advantageous embodiment of the present invention, in particular when the method has to be used by a charging management system for a large number of vehicles at the same time, is provided by the fact that, before and/or after moving the motor vehicle to the suitable charging position, the computing unit of the charging management system determines a stop position and preferably a stop period for the stop position, and that the motor vehicle is moved to the determined stop position and, if a stop period is determined, the motor vehicle is parked in the determined stop position preferably for the determined stop period. If one or more stop positions and one or more stop periods for these stop positions are determined prior to moving the motor vehicle to the suitable charging position, this determination can be part of determining the charging strategy and the respective moving can be part of the charging strategy. In this case, therefore, stop positions are directly assigned to the motor vehicle when the charging strategy is determined.

This makes it possible, for example, for a motor vehicle to first be moved to a stop position prior to charging the battery, where the motor vehicle waits for a specific period of time, for example until a previously blocked and/or reserved charging position and thus the assigned charging station is free, i.e. available. Such a stop position for parking a motor vehicle prior to charging its battery is referred to as a waiting position. Conversely, a motor vehicle can also be parked in a stop position after charging until the user of the motor vehicle wants to leave the parking lot. Such a stop position, which is used to park a motor vehicle after the charging process, is referred to as a parking position. Parking positions and waiting positions can be identical, but it can be advantageous to define specific areas of a parking lot for this purpose (for example waiting areas comprising a plurality of waiting positions; parking areas comprising a plurality of parking positions; pick-up areas, also comprising a plurality of parking positions, in this case also referred to in the context of this invention as pick-up positions in which motor vehicles are parked until they are picked up by the user of the motor vehicle), which are specified statically or dynamically, for example at certain times, by the charging management system.

It is in particular advantageous if, as part of the method according to an example embodiment of the present invention, the computing unit of the charging management system redetermines the charging strategy for the motor vehicle if another motor vehicle has transmitted its own charging request for its own battery to the second data transmission unit. The two charging requests can thus be optimally coordinated with one another. It is possible here that, even during the charging process of a first motor vehicle, the charging process of the battery of the first motor vehicle is interrupted if there is an urgent charging request for a battery of a second motor vehicle. If possible and necessary, the interrupted charging process can be continued later. Such a continuation can alternatively also be foregone. Users of the first motor vehicle could be informed of this, for example by means of a corresponding message on a mobile terminal device.

According to an example embodiment of the present invention, the charging strategy for the motor vehicle can preferably also be redetermined by the computing unit of the charging management system if the battery status or a component of the battery status has changed at least to an extent defined in advance (i.e. prior to use of the method). For this purpose, for example, the battery status or components of the battery status of the battery can be checked at regular intervals and, if there is a deviation from the battery status when the charging strategy is determined to a previously defined or greater extent (for example if there is a change of 5% or 10% or 20% of a parameter of the battery status), the battery status can be transmitted to the charging management system again. The charging management system could then determine a new charging strategy. The current battery status can alternatively also be transmitted to the charging management system at regular intervals and compared to the original battery status by the charging management system. Here, too, the charging strategy is redetermined if there are changes that have at least a previously defined extent. This ensures that an optimal strategy can always be selected for the motor vehicle. For instance, it could be that, due to a longer time interval between the time when the original charging strategy was determined and the planned charging time, the battery temperature has changed at least to a previously defined extent by the planned charging time, for example by 5% or 10% or 20%. Redetermining the charging strategy when such a temperature change is detected, makes it possible to ensure that an optimal charging strategy for the motor vehicle is nonetheless used.

A particularly advantageous embodiment of the method according to the present invention is provided by the fact that the motor vehicle is moved in a fully automated manner (driven in a fully automated manner) at least within the parking lot. It can thus be achieved that the motor vehicle is moved by the charging management system from a drop-off position (the position from which the motor vehicle is moved in a fully automated manner) to a waiting position and is parked there until the charging position determined by the charging strategy is free. After charging, the motor vehicle can be moved in a fully automated manner to a parking position where it is parked, for example until a time specified by the user of the motor vehicle. The user of the motor vehicle can then pick up the motor vehicle from this parking position. The parking area is then a pick-up area and the parking position is a pick-up position.

Alternatively, however, a pick-up area comprising pick-up positions can be defined separately as well, wherein pick-up positions are also stop positions within the meaning of the application, or a specific drop-off position can be defined.

Parking garages and parking lots with an automated parking system (AVP, automated valet parking) are especially suitable as parking lots for this variant of the present invention, which is based on fully automated motor vehicles. In such a case, the charging management system can be part of the automated parking system of the parking garage or the parking lot. In the case of an automated motor vehicle, it is moreover particularly advantageous if the battery of the motor vehicle is charged either inductively (i.e. wirelessly) or in an automated manner via a cable connection, for example by means of a robot.

In this context, it should be noted that the individual areas of a parking lot can be adjoining, but do not have to be. The areas can be spatially completely separated from one another, for example located in different parts of the city. This is useful if the intent is to take advantage of existing infrastructure such as existing parking garages, but the required charging stations can only be built elsewhere. For movement over longer distances between areas, the use of motor vehicles that can drive in a fully automated manner even without the assistance of an AVP system is advantageous in order to not have to be dependent on human drivers.

Although structurally contiguous or spatially adjoining areas (waiting, parking and/or pick-up area) are an important form of implementation of the present invention, it should be emphasized that it can be advantageous to create or define a decentralized parking lot. This means that the waiting, parking and/or pick-up area and/or certain subareas of the waiting, parking and/or pick-up area are arranged spatially and physically (structurally) separately from one another; i.e., there are two spatially and physically separate smaller waiting areas, for instance, instead of one large one. Spatial separation here means a distance of 10 m, preferably 50 m, and particularly preferably 100 m. It is also possible that, in extreme cases, even individual waiting, parking and pick-up positions are spatially and physically distributed. Assuming a possible fully automated movement of the motor vehicles, spatial proximity is advantageous, but not a mandatory prerequisite for the implementation of the present invention.

An advantageous area of use of the present invention for such a decentralized parking lot is the case that a large number of motor vehicles have to be charged over a relatively short period of time and the vehicles then have to be moved back to their old, further apart positions. One example of this would be private cars in one or more residential areas: assuming fully automated motor vehicles, when they are not needed, for example at night, they can drive from their local parking places near the residences of their owners (the waiting positions) to a central charging area of the parking lot as soon as a charging position is free, and drive back to the original location (the original waiting position, which is now a pick-up and parking position) after charging.

According to another aspect of the present invention, a charging management system for a parking lot, for example a parking garage, a parking space, a large parking garage and/or an underground parking garage, comprising a plurality of stop positions and a charging position with a charging station is proposed, wherein the charging management system comprises a data transmission unit and a computing unit and the data transmission unit is configured to receive a charging request for a battery of a motor vehicle and transmit it to the computing unit, wherein the computing unit is configured to ascertain a charging strategy for the motor vehicle. This charging strategy is then preferably sent from the data transmission unit of the charging management system to a data transmission unit of the motor vehicle and/or a mobile terminal device of a user (for example, a driver of the motor vehicle). The charging management system is preferably configured to be used in a method according to the present invention.

According to a further aspect of the present invention, a parking lot is provided, for example a parking garage, a parking space, a large parking garage and/or an underground parking garage, comprising a plurality of stop positions and a charging position with a charging station, wherein the parking lot is assigned a charging management system according to the present invention.

The parking lot according to the present invention and the associated charging management system can also be configured according to the present invention in such a way that the batteries of the parked electric vehicles or hybrid cars can be used in the stop positions as intermediate energy stores (vehicle-to-grid, V2G). The only requirement is that the charging strategy be defined such that the motor vehicle is charged as needed when it is scheduled to continue driving. Such a use therefore lends itself in particular to longer parking periods. In such a type of use, autonomous movement of the motor vehicles is particularly advantageous in order to be independent of a human driver and to be able to charge, but also discharge, the motor vehicles as needed.

Such a parking lot according to the present invention preferably comprises two, three, four, five or more, for example ten, charging positions and/or two, three, four, five or more, for example ten, stop positions in order to enable smooth handling of charging requests even for a large number of vehicles.

The present invention provides a variety of advantages. By optimizing the capacity utilization of charging stations of a parking lot when using the present invention, fewer charging stations have to be provided for the parking lot and efficient use of the infrastructure is achieved. The demand for charging stations can consequently be decreased overall by the approach according to the present invention, as a result of which costs for new construction or new acquisition of corresponding charging stations are reduced. The application of the present invention also promotes the use of electric cars, because the users no longer have to worry that the used motor vehicles cannot be sufficiently charged, for example due to blocked charging stations.

If the expected remaining battery lives after the charging process are taken into account in accordance with the present invention when determining the charging strategies for the motor vehicles, it is also possible to ensure that the batteries of the motor vehicles are protected as much as possible when being charged in a parking lot according to the present invention. The available charging stations are thus optimally utilized while at the same time protecting the service life of the batteries of the motor vehicles as much as possible.

The present invention is in particular suitable for use at airports or train stations, because a large number of electric cars to be charged can be expected there, and they are also often parked there for an extended period of time (for instance for several days). In this case, the use of the present invention within the framework of a vehicle-to-grid system is particularly advantageous. A motor vehicle does not have to be charged until directly prior to being picked up by the user.

### BRIEF DESCRIPTION OF THE DRAWINGS

Embodiments of the present invention are explained in more detail with reference to the figure and the following description.

FIG. 1 shows a schematic illustration of a parking lot according to the present invention for motor vehicles with a charging management system according to the present invention.

FIG. 2 shows a flow chart of method according to the present invention.

FIG. 3 shows a diagram illustrating possible communications between the charging management system according to the present invention and the mobile terminal device.

### DETAILED DESCRIPTION OF EXAMPLE EMBODIMENTS

In the following description of the example embodiments of the present invention, identical or similar elements are denoted by identical reference signs, wherein a repeated description of these elements is omitted in individual cases. The figures show the subject matter of the present invention only schematically.

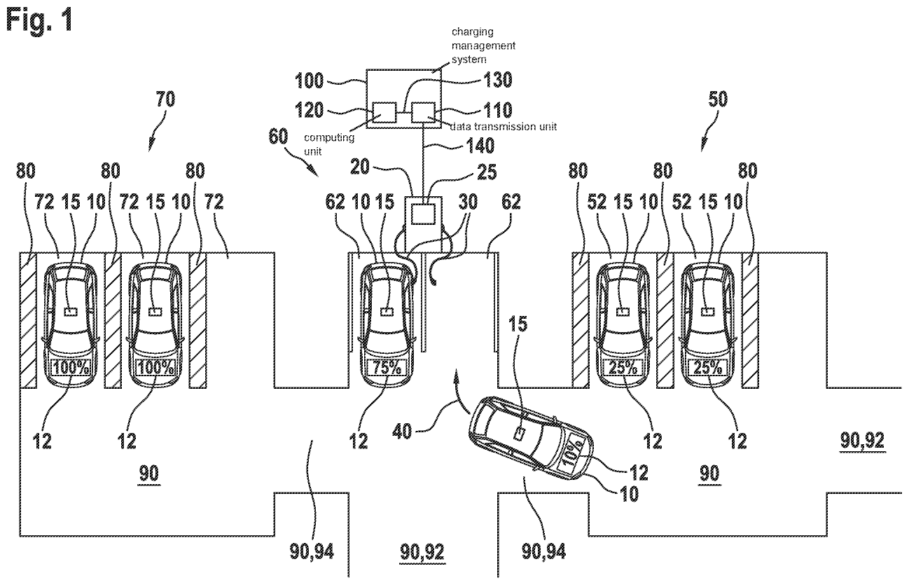

FIG. 1 shows a schematic illustration of an example embodiment of a parking lot according to the present invention for motor vehicles 10 with a charging management system 100 according to the present invention, wherein motor vehicles 10 comprising batteries 12 (for example electric vehicles) are shown, in which the method according to the present invention for carrying out an automated charging process is used. In FIG. 1, the symbols for the batteries 12 of the motor vehicles 10 show respective percentages that indicate example states of charge of the batteries 12 and are intended solely to illustrate the method according to the present invention.

The shown parking lot includes a waiting area 50 comprising a plurality of waiting positions 52 (as stop positions), a charging area 60 comprising a plurality of charging positions 62, a pick-up area 70 comprising a plurality of pick-up positions 72 which are also parking positions (and thus stop positions), and a plurality of roads 90. The different areas 50, 70 are configured as parking lots and are connected amongst one another by roads 94. This is therefore a decentralized parking lot, because there is spatial separation of the three areas 50, 60, 70. Motor vehicles 10 can reach and also leave the parking lot again via access roads 92 from public roads. In the present case, the connecting roads 94 between the areas 50, 60, are part of the parking lot, but such connecting roads 94 can generally also be part of a public road network. The figure further shows pedestrian areas 80 that indicate areas in which pedestrians, for example users of the motor vehicles 10, can move without being endangered by the motor vehicles 10 that preferably move between the three areas 50, 60, 70 in a fully automated manner.

The parking lot is also assigned to a charging management system 100 according to the present invention, which includes a data transmission unit 110 that is connected in a wired manner to a computing unit 120 via a cable 130. A wireless connection between the data transmission unit 110 and the computing unit 120 is alternatively possible too. The charging management system 100 can be a system that can be accessed via the Internet, for instance. The data transmission unit 110 is configured to receive charging requests for batteries 12 of motor vehicles 10 and can, for example, also be configured such that it is used to transmit a charging strategy and/or parts thereof to a data transmission unit 15 assigned to a motor vehicle 10 and/or a data transmission unit 25 of a charging station 20.

Such a charging station 20 is assigned in FIG. 1 to the charging positions 62. By means of a cable 30, a connection can be established between the charging station 20 and a motor vehicle 10 to transmit electrical energy and charge a battery 12 of the motor vehicle 10. The data transmission unit 25 of the charging station 20 and the data transmission unit 110 of the charging management system 100 can be connected to one another by means of a cable 140 or alternatively via a radio link (for example WLAN). The computing unit 120 connected to the data transmission unit 110 can thus be informed of the status of the charging station 20.

An arriving motor vehicle 10 comprising a battery 12 or its user can send a charging request including a battery status of the battery 12 (for instance including an actual state of charge) to the data transmission unit 110 of the charging management system 100 by means of a data transmission unit 15 assigned to the motor vehicle 10 (i.e. can be part of the motor vehicle 10, for example, but can also be a mobile terminal device 300). The charging request is forwarded in the charging management system 100 to a computing unit 120, which, for example based on said request and the already existing charging requests for batteries 12 of other motor vehicles 10 and/or the status of the other motor vehicles 10 on the parking lot and/or the status of the charging station 20, ascertains a charging strategy. Such a charging strategy specifies a charging time and a charging duration for the requesting motor vehicle 10. Taking into account the charging strategies of other motor vehicles 10 that have sent a charging request to the charging management system 100, a charging strategy for the arriving motor vehicle 10 can now be determined, in particular, a charging duration and a charging time and a suitable charging position 62.

Since the number of available charging positions 62 of a parking lot is typically limited, it is possible that an arriving motor vehicle 10 will be parked in a waiting area 50 until a charging position 62 becomes available. A waiting position 52 of the waiting area 50 can be specified by the computing unit 120 of the charging management system 100. At a given time, for example at a specified time of day, the motor vehicle 10 is moved to the charging position 62 determined by the charging management system 100 or its computing unit 120 (arrow 40) and the battery 12 of the motor vehicle 10 is charged there by the associated charging station 20 in accordance with the charging strategy at a charging time and for a charging duration. In the process, parts of the charging strategy or the overall charging strategy can have been transmitted to the charging station 20 and/or the motor vehicle 10 by the data transmission unit 110 of the charging management system 100. It is also possible that the motor vehicle 10 transmits data to the charging station 20, for example, the charging duration. The movement of the motor vehicle 10 within the parking lot is preferably fully automated. Upon reaching the waiting area 50, the user in the example shown in FIG. 1 can leave the motor vehicle 10 via the pedestrian area 80.

After the charging process, the motor vehicle 10 comprising the battery 12 that is now charged in accordance with the charging strategy (illustrated in FIG. 1 with the indication 100%) is moved to the pick-up area 70. This movement, too, is preferably fully automated. There, the motor vehicle 10 is parked in a pick-up position 72 until the user picks it up; i.e. the user gets into the motor vehicle 10. The motor vehicle 10 is then moved out of the parking lot via one of the access roads 92. Here, it is also possible that the user drives the motor vehicle again, in which case the user can safely reach the motor vehicle 10 via the pedestrian area 80.

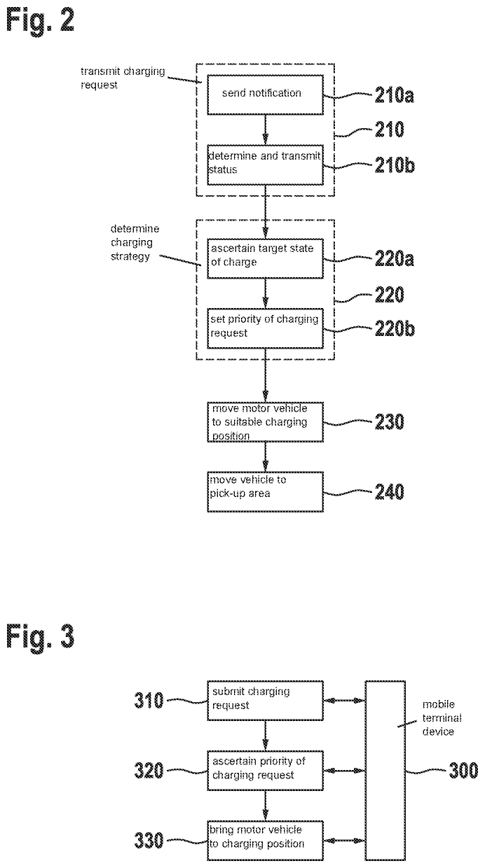

FIG. 2 schematically shows a method according to the present invention for carrying out an automated charging process for a battery 12 of a motor vehicle 10 as a flow chart. In a first step 210, a charging request is first transmitted to the data transmission unit 110 of a charging management system 100 according to the present invention of a parking lot. In the present example, this step 210 can be divided into two substeps 210a, 210b: In step 210a, a notification that charging is desired is sent to the charging management system 100 of a parking lot according to the present invention by the motor vehicle 10 or its user, for example via a corresponding app on a smartphone. The charging management system 100 then requests information about the battery status from the motor vehicle 10 or the mobile terminal device 300. Said status is then determined and transmitted in step 210b. Therefore, in this example, the battery status is transmitted only in response to the request of the charging management system 100, but this is overall nonetheless only one charging request within the meaning of the present invention. Thus, in step 210, all of the information relating to the battery 12 relevant to determining a charging strategy has been transmitted to the charging management system 100 by a charging request.

Based on this and preferably also taking into account an expected remaining battery life of the battery 12 and, if necessary, also taking into account other existing charging requests and information relating to the infrastructure of the parking lot (such as waiting positions 52, parking positions 72 and charging positions 62 as well as charging stations 20), the charging management system 100 or its computing unit 120 then determines a charging strategy in a step 220. This step can often be subdivided into substeps: A planned route for the motor vehicle 10 could have been transmitted as part of the charging request, for instance. Based on information relating to the battery 12, such as the current actual state of charge of the battery 12 and said planned route, a target state of charge can be ascertained in step 220a in order to determine a minimum charging duration needed to reach the next destination on the route or at least another charging station. Taking into account the charging requests for batteries 12 of other motor vehicles the priority of the charging request for the battery 12 of the motor vehicle 10 can now be set in step 220b, and a suitable charging position, a charging time and charging duration can be determined as part of a charging strategy. Thus, a charging strategy is ascertained in steps 220a and 220b. If necessary, the charging strategies of other motor vehicles 10 are also adjusted, for example their charging times and charging durations, in order to enable as optimum as possible a prioritization of the charging processes of all of the motor vehicles 10 relative to one another.

Based on the determined charging strategy, in step 230, the motor vehicle 10 is moved to a suitable charging position 62 and the battery 12 is charged there according to the charging strategy. After the completion of the charging process, the motor vehicle 10 is moved to a pick-up area 70 in step 240, where it can be picked up by the user.

FIG. 3 lastly, likewise schematically, illustrates an example of a way of configuring the interplay between a charging management system 100 according to the present invention and a mobile terminal device 300 of a user of a motor vehicle 10. In step 310, the user of a motor vehicle 10 comprising a battery 12 can submit a charging request to the charging management system 100 of a parking lot via an app on a mobile terminal device 300. The app can be configured like a booking system. It is advantageous here if the user can use the app to directly transmit his or her requests, including parameters such as flexibility with regard to said requests, and also pay for parking and charging the motor vehicle 10 via said app. Based on this and taking into account a battery status of the battery 12 (for example transmitted with the charging request or also determined separately from the database of a corresponding cloud computing system) and preferably an expected remaining battery life, the charging management system 100 and/or its computing unit 120 ascertains the priority of this charging request in step 320 and optimizes it with respect to other existing charging requests and creates a corresponding charging strategy from this information and from information relating to the infrastructure of the parking lot. In step 330, after the user has left the motor vehicle 10, the user's motor vehicle 10 is brought to the determined charging position 62 at the planned time in a fully automated manner in accordance with the charging strategy. After charging the battery 12 and again in accordance with the charging strategy, the motor vehicle 10 is parked in the waiting area 50 until it is picked up by the user. It is possible that information relating to these steps is continuously transmitted to the mobile terminal device 300 and the user is informed, for instance about the progress of the charging process and/or the status of his or her motor vehicle by means of the app. It is also possible for the user to be able to intervene in the method. For example, it could be possible for him to change his mind and ask for his or her motor vehicle 10 back, if need be with a lower actual state of charge of the battery 12. This possible two-way flow of information in all steps is indicated symbolically in FIG. 3 with double arrows.

The present invention is not limited to the embodiment examples described here and the aspects highlighted therein. Rather, within the range of the present invention, a large number of modifications are possible which lie within the abilities of a person skilled in the art.

What is claimed is:

1. A method for carrying out an automated charging process for a battery of a motor vehicle, the method comprising the following steps:
transmitting a charging request for the battery of the motor vehicle from a first data transmission unit to a second data transmission unit which is part of a charging management system and is connected to a computing unit of the charging management system, wherein the charging management system is assigned a parking lot for motor vehicles, and the parking lot includes a plurality of stop positions;
determining a battery status of the battery;
determining, by the computing unit of the charging management system, a charging strategy for the motor vehicle for charging the battery taking into account the battery status;
moving the motor vehicle to a suitable charging position of the parking lot, and charging the battery of the motor vehicle according to the charging strategy in the suitable charging position by a charging station assigned to the suitable charging position at a charging time and for a charging duration, wherein at least the charging time and the charging duration arise from the charging strategy.

2. The method according to claim 1, wherein the battery is a drive battery of the vehicle.

3. The method according to claim 1, wherein the motor vehicle is an electric vehicle or a hybrid vehicle.

4. The method according to claim 1, wherein the determination of the charging strategy is carried out also taking into account an expected remaining battery life of the battery after the battery has been charged.

5. The method according to claim 1, wherein the battery status or a component of the battery status is part of the charging request and/or the battery status is transmitted to the charging management system separately from the charging request and/or the battery status is transmitted to the charging management system by an external computing unit connected to the charging management system.

6. The method according to claim 1, wherein the battery status includes a nominal voltage, and/or a battery capacity, and/or an energy content, and/or a power, and/or a self-discharge, and/or a charging rate, and/or a battery temperature, and/or a recommended charging method, and/or an actual state of charge of the battery.

7. The method according to claim 1, wherein the determination of the charging strategy includes determining and/or taking into account the suitable charging position and/or the charging time and/or the charging duration and/or a target state of charge and/or a method of charging the battery.

8. The method according to claim 4, wherein the determination of the charging strategy is carried out in such a way that the expected remaining battery life is maximized while complying with one or more requirements.

9. The method according to claim 1, wherein the determination of the charging strategy is carried out taking into account: i) other charging strategies of other motor vehicles, and/or ii) charging requests for batteries of other motor vehicles.

10. The method according to claim 1, wherein before and/or after moving the motor vehicle to the suitable charging position, the computing unit of the charging management system determines a stop position and a stop period for the stop position, and that the motor vehicle is moved to the determined stop position and the motor vehicle is parked in the determined stop position for the determined stop period.

11. The method according to claim 1, wherein the computing unit of the charging management system redetermines the charging strategy for the motor vehicle: i) when another motor vehicle has transmitted its own charging request for its own battery to the second data transmission unit, and/or ii) when the battery status or a component of the battery status has changed at least to an extent defined in advance.

12. The method according to claim 1, wherein the motor vehicle is moved within the parking lot in a fully automated manner.

13. A charging management system for a parking lot including a plurality of stop positions and a charging position with a charging station, the charging management system comprising:
a data transmission unit;
a computing unit;
wherein the data transmission unit is configured to receive a charging request for a battery of a motor vehicle and transmit it to the computing unit, wherein the computing unit is configured to ascertain a charging strategy for the motor vehicle, wherein the charging management system.

14. The charging management system according to claim 13, wherein the parking lot includes a parking garage, and/or a parking space, and/or a large parking garage, and/or an underground parking garage.

15. A parking lot, comprising:
a plurality of stop positions; and
a charging position with a charging station, wherein the parking lot is assigned a charging management system, the charging management system including:
a data transmission unit;
a computing unit;
wherein the data transmission unit is configured to receive a charging request for a battery of a motor vehicle and transmit it to the computing unit, wherein the computing unit is configured to ascertain a charging strategy for the motor vehicle, wherein the charging management system.

16. The parking lot according to claim 15, wherein the parking lot includes a parking garage, and/or a parking space, and/or a large parking garage, and/or an underground parking garage.
